(19) United States
(12) Patent Application Publication
(10) Pub. No.: US 2014/0110005 A1
(43) Pub. Date: Apr. 24, 2014

(54) Flow regulator for shower head

(71) Applicants: Kao-Jen Ho, Changhua (TW); Chao-Lun Ho, Changhua (TW)

(72) Inventors: Kao-Jen Ho, Changhua (TW); Chao-Lun Ho, Changhua (TW)

(21) Appl. No.: 13/659,898

(22) Filed: Oct. 24, 2012

(51) Int. Cl. G05D 7/01

(52) U.S. Cl. 138/43

(57) ABSTRACT

A flow regulator for a shower head includes a hollow cylindrical member including a plurality of spaced latches around a center, an annular cavity between the latches and an inner surface of the hollow cylindrical member, and a plurality of exit holes having both ends open in which a first end of the exit hole communicates with the cavity; an O-ring disposed in the cavity to engage the exit holes; and a ring member including a central channel and a plurality of spaced tunnels around the central channel, the ring member being fastened between the latches and the O-ring. The number of the tunnels is equal to that of the exit holes. The tunnels are aligned with the exit holes. A stable flow through the shower head can be carried out.

### BACKGROUND OF THE INVENTION

1. Field of the Invention

The invention relates to flow regulators and more particularly to a flow regulator for a shower head.

2. Description of Related Art

A conventional flow regulator for shower head is shown in FIGS. 1, 2 and 3 and comprises a cylindrical member A comprises an internal, annular cavity A1, a plurality of exit holes A2 having one end communicating with the cavity A1 and the other end open, and a plurality of equally spaced latches A3 around a center of the cylindrical member A. A flexible O-ring B is disposed in the cavity A1.

However, the O-ring B may be pushed by the large, strong water (as indicated by arrows) to engage a shoulder with about two thirds of the exit holes A2 being blocked (see FIG. 2). To the contrary, the O-ring B may be pushed by the small, weak water (as indicated by arrows) to engage latching ends of the latches A3 (see FIG. 3). Disadvantageously, the flow rate may be not stable in response to flow rate change. Thus, the need for improvement still exists.

### SUMMARY OF THE INVENTION

It is therefore one object of the invention to provide a flow regulating device for a shower head comprising a hollow cylindrical member comprising a plurality of spaced latches around a center, an annular cavity between the latches and an inner surface of the hollow cylindrical member, and a plurality of exit holes having both ends open in which a first end of the exit hole communicates with the cavity; an O-ring disposed in the cavity to engage the exit holes; and a ring member comprising a central channel and a plurality of spaced tunnels around the central channel, the ring member being fastened between the latches and the O-ring; wherein the number of the tunnels is equal to that of the exit holes; and wherein the tunnels are aligned with the exit holes.

The above and other objects, features and advantages of the invention will become apparent from the following detailed description taken with the accompanying drawings.

### BRIEF DESCRIPTION OF THE DRAWINGS

FIG. 1 is an exploded perspective view of a conventional flow regulator for shower head;

FIG. 2 is a longitudinal sectional view of the assembled flow regulator in response to strong water flow;

FIG. 3 is a view similar to FIG. 2 showing the flow regulator in response to weak water flow;

FIG. 4 is an exploded perspective view of a flow regulator according to the invention;

FIG. 5 is a partially broken away view of the assembled flow regulator of FIG. 4;

FIG. 6 is another partially broken away view of the assembled flow regulator of FIG. 4;

FIG. 7 is a sectional view of the assembled flow regulator of FIG. 4;

FIG. 8 is a longitudinal sectional view of the flow regulator in response to weak water flow;

FIG. 9 is a view similar to FIG. 8 showing the flow regulator in response to strong water flow;

FIG. 10 is an exploded perspective view of the flow regulator to be mounted in a shower head according to a first preferred embodiment of the invention;

FIG. 11 is a longitudinal sectional view of the assembled shower head of FIG. 10;

FIG. 12 is an exploded perspective view of the flow regulator to be mounted in a shower head according to a second preferred embodiment of the invention; and

FIG. 13 is a longitudinal sectional view of the assembled shower head of FIG. 12.

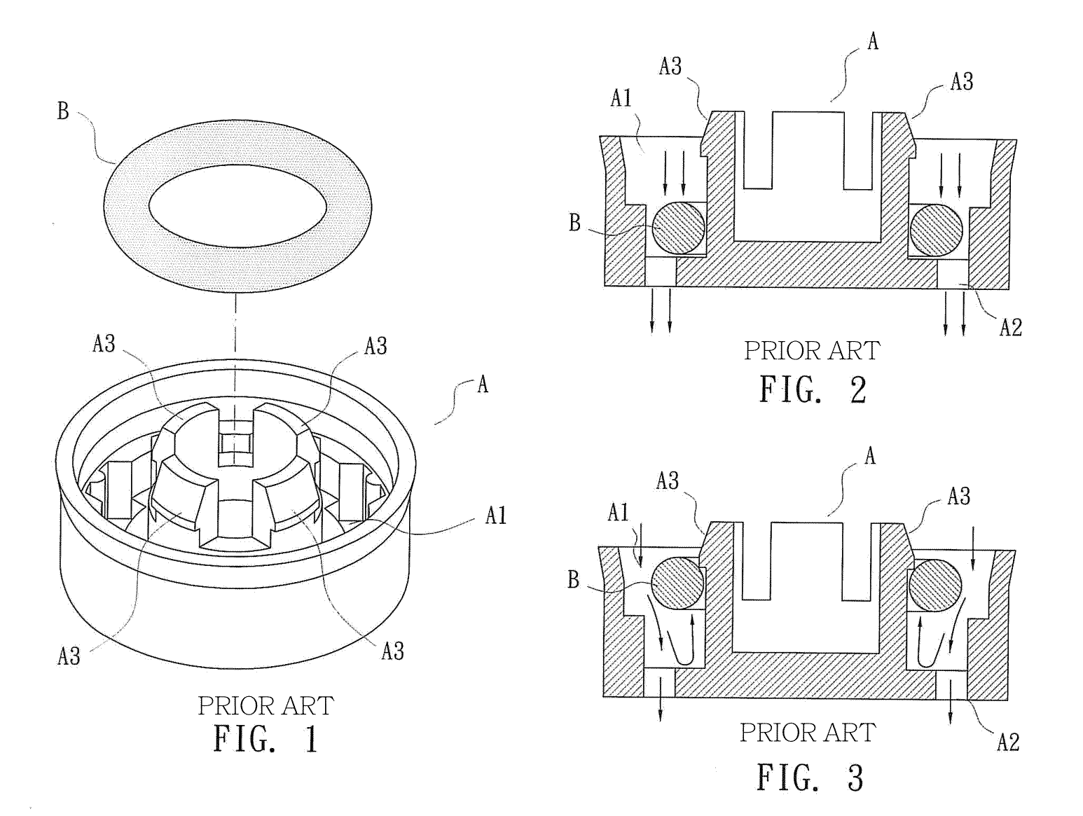

### DETAILED DESCRIPTION OF THE INVENTION

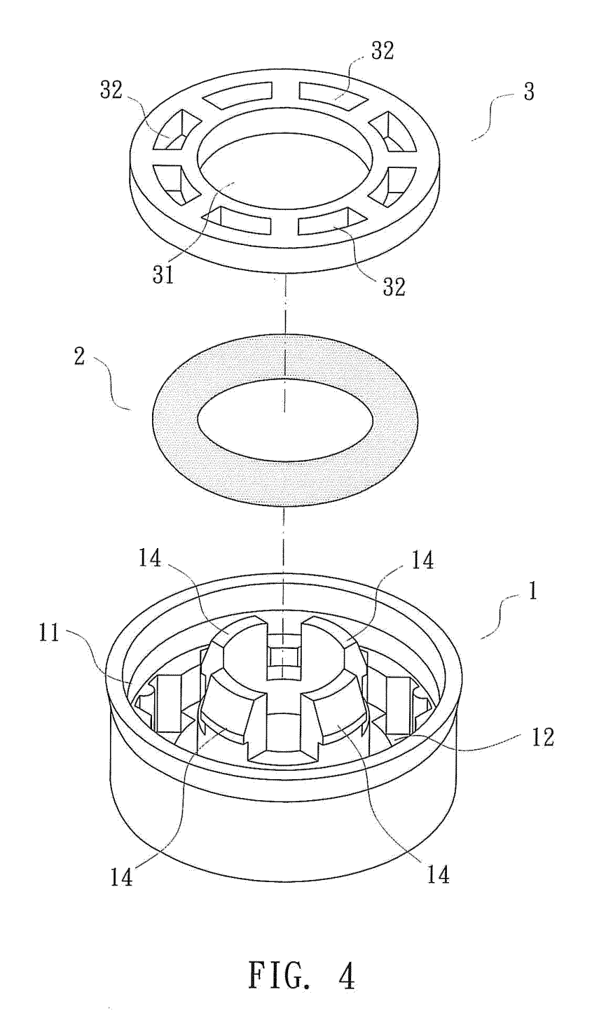

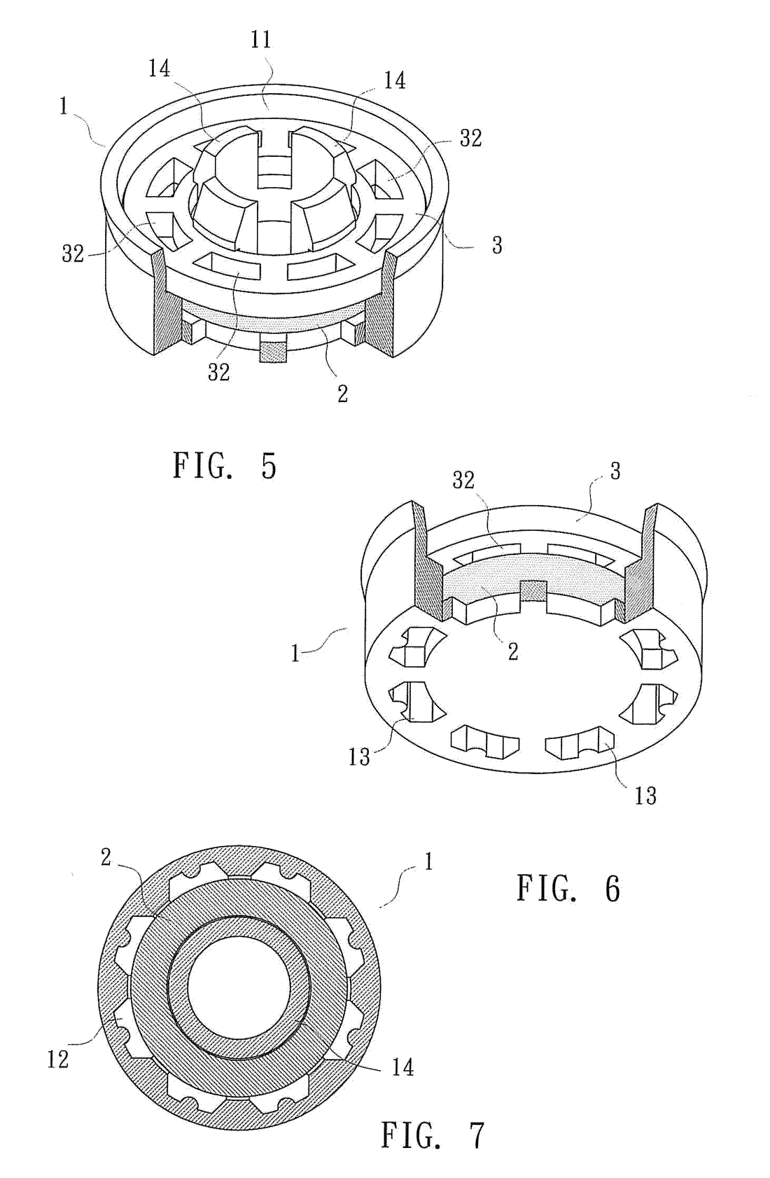

Referring to FIGS. 4 to 13, a flow regulator for a shower head in accordance with the invention comprises the following components as discussed in detail below.

A cylindrical member 1 comprises a space 11, an annular cavity 12 on the bottom of the space 11, a plurality of exit holes 13 having one end communicating with the cavity 12 and the other end open, and a plurality of equally spaced latches 14 around a center of the space 11. A flexible O-ring 2 is disposed in the cavity 12 to engage the exit holes 13. A ring member 3 comprises a central channel 31 and a plurality of equally spaced tunnels 32 around the channel 31. The ring member 3 is anchored between the latches 14 and the O-ring 2 by putting the channel 31 on root portions of the latches 14. The ring member 3 engages the O-ring 2. The number of the tunnels 32 is the same as that of the exit holes 13. Further, the tunnels 32 are aligned with the exit holes 13.

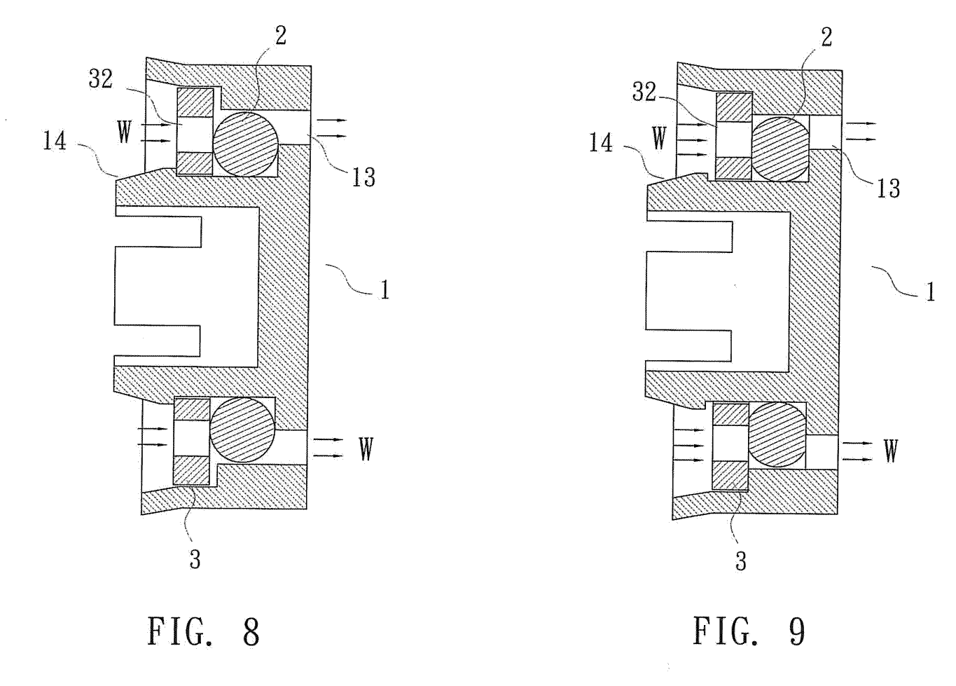

As shown in FIGS. 8 and 9, the O-ring 2 may be compressed by the ring member 3 in response to water W flowing from the tunnels 32 to the exit holes 13 in which the O-ring 2 is almost not compressed when water W flow is small (see FIG. 8) and in contrast the O-ring 2 is significantly compressed when water W flow is large (see FIG. 9). In short, the higher of the water pressure the more of the O-ring 2 is compressed.

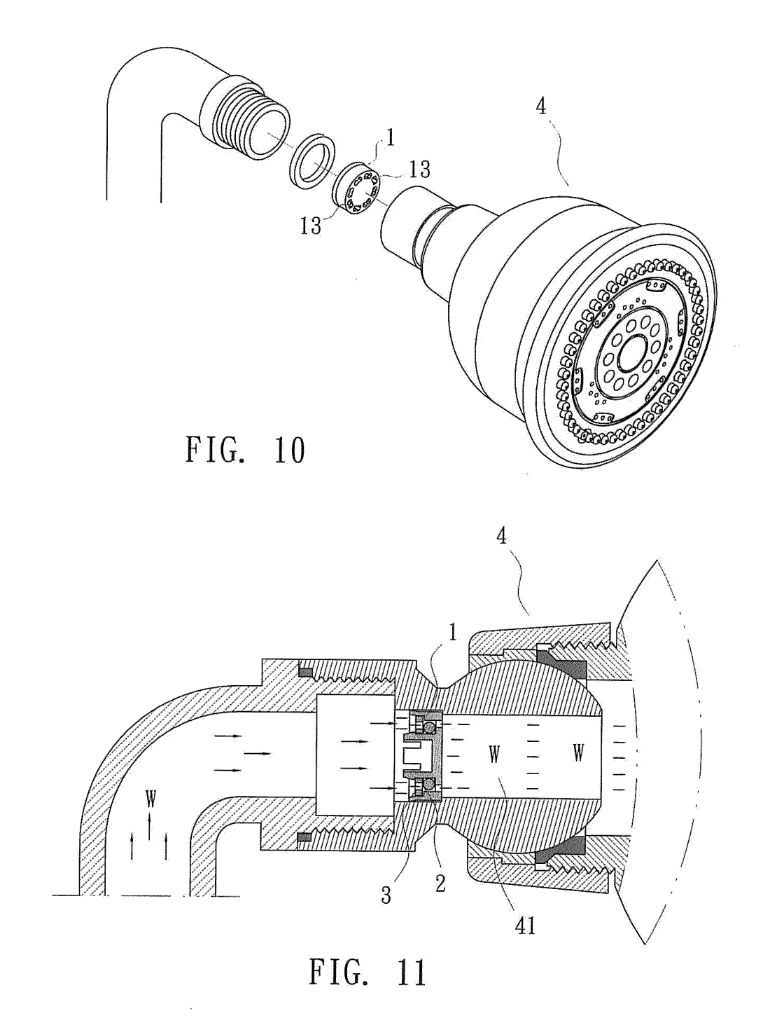

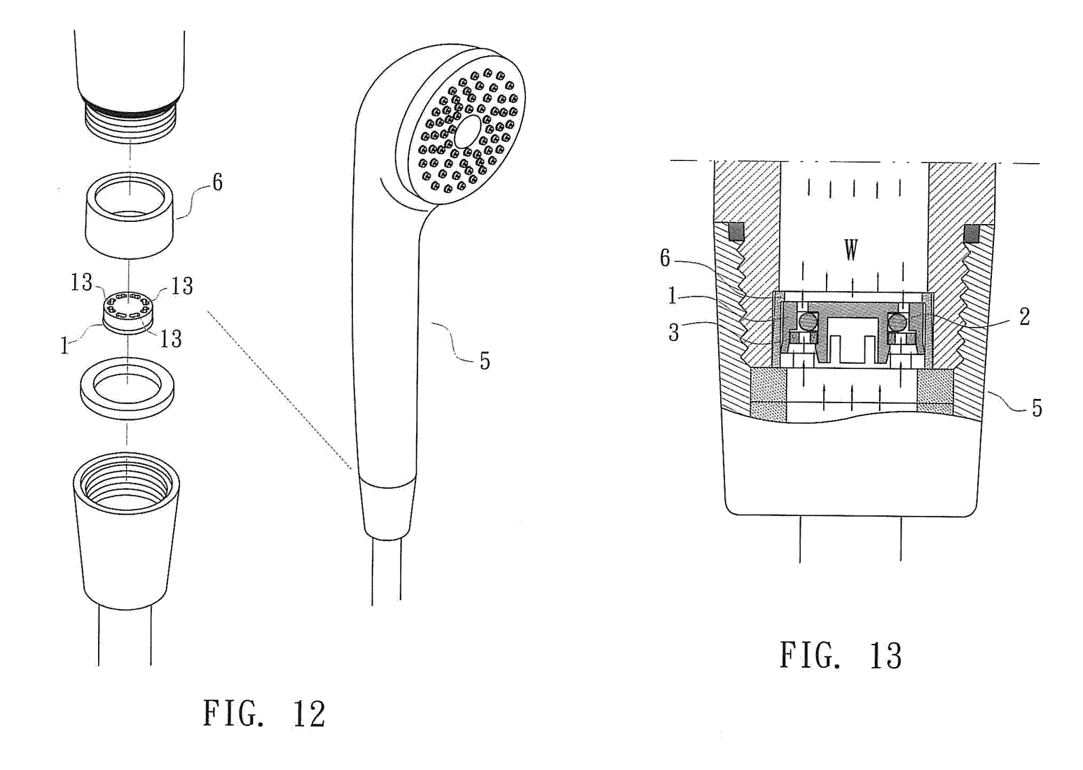

As shown in FIGS. 10 and 11, in a first preferred embodiment the flow regulator is mounted in a passageway 41 of a universal joint of a shower head 4.

As shown in FIGS. 12 and 13, in a second preferred embodiment the flow regulator is mounted in a sleeve 6 which is in turn mounted in a passageway 41 at a joining portion of a shower head 5 and a plastic tubing.

It is envisaged by the invention that a stable flow through the shower head can be carried out.

While the invention has been described in terms of preferred embodiments, those skilled in the art will recognize that the invention can be practiced with modifications within the spirit and scope of the appended claims.

What is claimed is:

1. A flow regulating device comprising:
a hollow cylindrical member comprising a plurality of spaced latches around a center, an annular cavity between the latches and an inner surface of the hollow cylindrical member, and a plurality of exit holes having both ends open in which a first end of the exit hole communicates with the cavity;
an O-ring disposed in the cavity to engage the exit holes; and
a ring member comprising a central channel and a plurality of spaced tunnels around the central channel, the ring member being fastened between the latches and the O-ring;
wherein the number of the tunnels is equal to that of the exit holes; and
wherein the tunnels are aligned with the exit holes.
